(19) United States
(12) Patent Application Publication
(10) Pub. No.: US 2026/0253574 A1
(43) Pub. Date: Aug. 27, 2026

(54) Machine Learning (ML) Based Road Noise Cancelation (RNC) with User Position Tracking

(71) Applicant: Bose Corporation, Framingham, MA (US)

(72) Inventors: Elie Bou Daher, Auburn, MA (US); Arjun Gupta, Boston, MA (US); Cristian Marius Hera, Lancaster, MA (US)

(21) Appl. No.: 19/059,504

(22) Filed: Feb. 21, 2025

(51) Int. Cl. G10K 11/178

(52) U.S. Cl. CPC G10K 11/17857; G10K 11/17881; G10K 2210/12821

(57) ABSTRACT

Various implementations include noise cancelation (NC) systems and related approaches for NC. Certain implementations include a system including: a vehicle audio system including at least one transducer for providing an audio output to an occupant in a vehicle; a position sensor for indicating a position of the occupant in the vehicle; a set of additional sensors including an accelerometer; and a machine learning (ML) based road noise cancelation (RNC) system connected with the vehicle audio system and the position sensor, the ML based RNC system configured to: receive inputs from the vehicle audio system, the position sensor, and the accelerometer; apply a set of parameters defining noise cancelation signals based on the inputs; and generate noise cancelation signals for output by the at least one transducer based on the applied set of parameters.

### TECHNICAL FIELD

This disclosure generally relates to audio systems. More particularly, the disclosure relates to noise cancelation in a vehicle.

### BACKGROUND

Conventional noise cancelation (NC) systems can fail to adequately mitigate noise for vehicle occupants. Certain of these conventional systems aim to minimize an error signal that represents undesired sound at a remote location, e.g., at a user's ear location. While these conventional systems provide various benefits, they may fail to accurately account for actual road noise detected by a user.

### SUMMARY

All examples and features mentioned below can be combined in any technically possible way.

Various implementations include audio systems and related approaches for providing noise cancelation (NC), and in particular examples, road noise cancelation (RNC). Various noise-cancelation systems herein use inputs from position sensors to detect noise-impacting conditions and adjust noise cancelation signals based on those position sensor inputs.

In some particular aspects, a system includes: a vehicle audio system including at least one transducer for providing an audio output to an occupant in a vehicle; a position sensor for indicating a position of the occupant in the vehicle; a set of additional sensors including an accelerometer; and a machine learning (ML) based road noise cancelation (RNC) system connected with the vehicle audio system and the position sensor, the ML based RNC system configured to: receive inputs from the vehicle audio system, the position sensor, and the accelerometer; apply a set of parameters defining noise cancelation signals based on the inputs; and generate noise cancelation signals for output by the at least one transducer based on the applied set of parameters.

In additional particular aspects, a method of controlling road noise in a vehicle with a machine learning (ML) based road noise cancelation (RNC) system, the method including: receiving inputs from a vehicle audio system, a position sensor, and an accelerometer, wherein the position sensor indicates a position of an occupant in the vehicle; applying a set of parameters defining noise cancelation signals based on the inputs; and generating noise cancelation signals for output by at least one transducer in the vehicle audio system based on the applied set of parameters.

Implementations may include one of the following features, or any combination thereof.

In some cases, the set of parameters are further applied based on a detected position of a seat in which the occupant is located.

In some cases, the noise cancelation signals are configured to cancel road noise at frequencies of approximately 400 hertz (Hz) or higher.

In some cases, the noise cancelation signals are configured to cancel road noise at frequencies of approximately 600 Hz or higher.

In some cases, the ML based RNC system is configured to run in a plurality of modes.

In some cases, the position sensor provides at least one coordinate indicator of a position of each ear of the occupant of the vehicle.

In some cases, the position sensor has a resolution that results in a delay between changes in the position of each ear of the occupant and changes in coordinate indicator.

In some cases, a hysteresis factor is applied to adjustments in the cancelation signal based on the resolution of the position sensor.

In some cases, the RNC system is configured to select a default position of the occupant based on at least one of: i) detecting the position of the occupant during startup of the vehicle, ii) detecting the position of the occupant at a cruising speed of the vehicle, iii) a profile of the occupant, or iv) at least one occupant input defining the default position.

In some cases, the position sensor includes two or more optical sensors.

In some cases, the ML based RNC system is further configured to receive inputs from the set of additional sensors including: a set of cabin microphones in the vehicle, and a controller area network (CAN) bus.

In some cases, the inputs from the CAN bus include at least one vehicle input including: revolutions per minute (RPM) of the drive system, speed, torque, throttle, braking, positioning, steering angle, temperature, pressure, seat position, or seat occupancy.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a schematic depiction of a noise cancelation system according to various disclosed implementations.

FIG. 2 is a schematic depiction of a noise cancelation system according to various additional disclosed implementations.

FIG. 3 is a data flow diagram illustrating aspects of an operational model for position-based selection of projection filters according to various implementations.

FIG. 4 is a data flow diagram illustrating the architecture of an ML system, during a training mode, according to various implementations.

FIG. 5 is a data flow diagram illustrating the architecture of an ML system, during an operational mode, according to various implementations.

FIG. 6 is a flow diagram illustrating processes in a method of operating a noise cancelation system including a ML system according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that a noise cancelation (NC) system for a vehicle can be enhanced using inputs from position sensors that indicate a position of an occupant. Various noise-cancelation systems herein use inputs from position sensors to adjust noise cancelation signals based on those position sensor inputs.

Additional implementations include a NC system such as a road noise cancelation (RNC) system that includes a machine learning (ML) system configured to generate noise cancelation signals for output by a transducer based on an applied set of parameters. The parameters are applied based on inputs from position sensors, an accelerometer, and the vehicle audio system. Related methods are also disclosed for ML based noise cancelation signal generation. In some cases, the ML system is configured to apply a set of parameters based on inputs, and generate noise cancelation signals for output by the transducer based on the applied set of parameters. Particular implementations include ML based generation of cancelation signals and/or estimated ear error signals during operation of a vehicle using one or more position sensor inputs.

The disclosed implementations rely on inputs from position sensors, during operation of the RNC system and/or during training of an RNC system. In particular cases, the position sensor(s) provides at least one coordinate indicator of each ear of the occupant(s) of the vehicle. In certain cases, the position sensor includes two or more optical sensors, which in particular examples, includes two or more optical sensors such as cameras positioned to detect the position of a user's head and/or ears. Additional position sensors can include optical sensors such as fiber optic sensors, etc.

In various implementations, the ML system can be trained to detect noise-impacting conditions from position sensor inputs and adjust noise cancelation signals based on those position sensor inputs.

Additional aspects of an RNC system that may or may not deploy an ML system as described herein are described for example, in US patent application Ser. No. 18/971,140 (Road Noise Cancelation (RNC) with User Position Tracking, filed Dec. 6, 2024) and Ser. No. 19/044,811 (Noise Cancelation (NC) in Vehicle with Optical Tracking, filed Feb. 4, 2025), the entire contents of each of which is hereby incorporated by reference herein.

Commonly labeled components in the FIGURES are considered to be substantially equivalent components for the purposes of illustration, and redundant discussion of those components is omitted for clarity.

### Vehicle Noise Cancelation

Sound cancelation systems that cancel or reduce undesired sounds in a predefined volume, such as road noise (and in some additional cases, harmonic) cancelation in a vehicle cabin, often employ a feedback sensor (such as a microphone) to generate an ear (or, error) signal (or, feedback signal) representative of residual uncanceled sounds. This ear (or, error) signal is fed back to an adaptive filter that adjusts a cancelation signal in an attempt to minimize the residual uncanceled sound.

However, in some contexts, the feedback sensor may not be positioned at an optimal location. For example, in the vehicle context, the feedback sensor may be placed in the roof, pillar, or headrest, but the undesired sound should be canceled at a passenger's ears. As a result, the ear (or, error) signal is indicative of the error at the feedback sensor, but not at the passenger's ears. This is undesirable because the objective of the cancelation system is to cancel undesired sounds at the passenger's ears. Placing microphones on passenger's ears, however, is impractical and likely unacceptable to the passenger. In some examples, however, a priori measurements by a microphone placed at an ear location may determine an acoustic relationship between the ear location and the feedback sensor location. Accordingly, the feedback sensor signal (e.g., a cabin mic) may be ‘projected’ to an equivalent ear mic signal. Alternatively stated, a cabin (e.g., roof, seatback/headrest, panel, dashboard, windshield, etc.) mic signal may be filtered (based upon the acoustic relationship between the two locations) to provide a virtual ear mic signal. In various examples, the acoustic relationship between the feedback sensor location and the passenger ear location may vary depending upon vehicle and cabin conditions as described herein, such that the filter may be selected based upon such vehicle and/or cabin conditions.

In addition, sound canceling audio signals—in the vehicle and other contexts—are typically delayed approximately five milliseconds, as the audio signal must travel from a speaker disposed along the perimeter of the vehicle cabin to the passenger's ears (e.g., the canceling audio signal must travel from approximately five feet away from the passenger's ear, and the speed of sound is approximately one foot per millisecond). This delay prevents optimal canceling because the canceling audio signal, as perceived by the passenger is directed toward sound that has already occurred. Accordingly, some examples may include features to predict future values of the residual sound at the occupant's ear without placing a microphone at the occupant's ear. Further details of predicting sound or residual sound may be found in U.S. Pat. No. 10,629,183 issued on Apr. 21, 2020, Titled Systems and Methods for Noise-cancelation USING MICROPHONE PROJECTION, which is incorporated herein in its entirety for all purposes.

Various examples disclosed herein include a cancelation system that estimates an ear (or, error) signal representative of residual uncanceled sound at a location remote from the feedback sensor. The estimation, in an example, is based on available information from, namely, remote reference microphones, and from knowledge of the relationship between those remote microphones and the sound field at the passenger's ears and of the output of the sound cancelation system itself. In particular examples, position sensors are used to detect a position of the user (and in some cases, the user's ear) to provide additional knowledge of the sound field at the passenger's ears. The resulting adjustment to the adaptive filter, based on the estimated ear signal, will minimize the estimated ear signal and thus cancel the undesired sound at the remote location rather than at the feedback sensor, e.g., effectively projecting the feedback sensor to the remote location. This may alternately be understood as shifting the cancelation zone from the feedback sensor to the location remote from the feedback sensor. In particular implementations, the cancelation system includes a machine learning (ML) system that is configured to be deployed at the vehicle to generate cancelation signals during operation of the vehicle.

### Road Noise Cancelation (NC) with Position Sensing/Tracking

In particular cases, disclosed embodiments include a system including: a vehicle audio system, a vehicle sensor system with, among other sensors, an accelerometer and a set of position sensors, and a road noise cancelation (RNC) system that includes a ML system. In some cases, the ML module is configured to: i) receive inputs from the vehicle audio system and the vehicle sensor system (including inputs from the accelerometer and position sensors), and ii) apply a set of parameters defining an estimated signal detected at the user's ears. The ML module is also configured to generate noise cancelation signals for output based on the applied set of parameters. Additional implementations include training a RNC system, and/or running a RNC system.

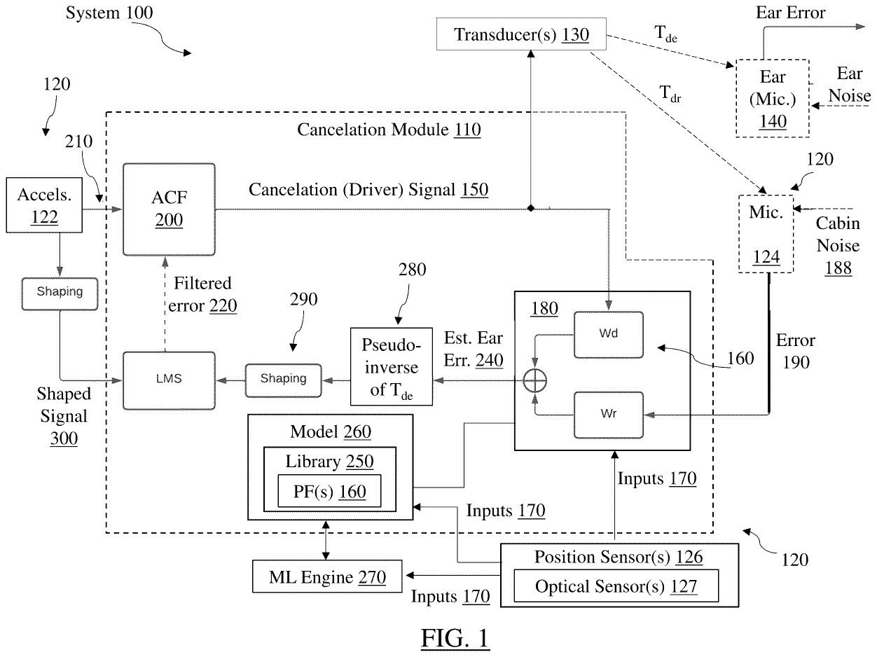

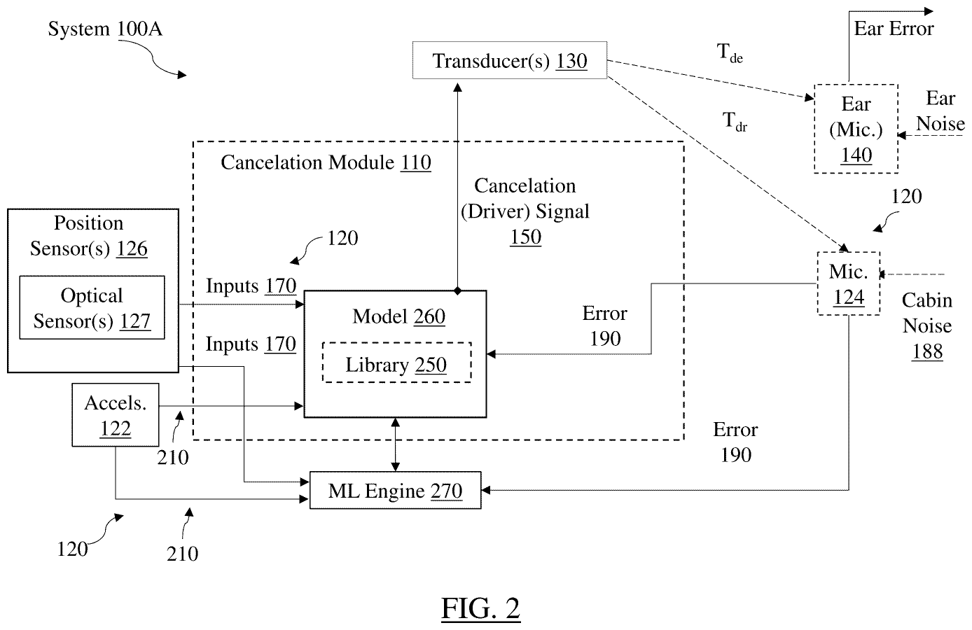

FIG. 1 is a schematic signal flow diagram of illustrating aspects of a position-based noise cancelation system, e.g., an NC system such as an RNC system (or simply, system) 100 according to various implementations. FIG. 2 is a schematic signal flow diagram illustrating aspects of a position-based NC system (e.g., an RNC system) 100A according to various additional implementations. As noted herein, system 100A depicts a simplified version of system 100 (FIG. 1), whereby various functions of components in a cancelation module are performed directly by an operational model that may include a machine learning (ML) engine. Commonly labeled components between the FIGURES may have substantially similar features.

Turning to FIG. 1, system 100 can include a noise cancelation component that is configured to cancel road noise, and in some optional cases, engine harmonic noise. As noted herein, in some cases, system 100 may be configured to reduce the audible noise detected from the interaction of the vehicle with the road, as well as other ambient noise detectable by the user. Portions of the signal flow diagram illustrate electrical paths such as electrical connections between components. Further portions of the signal flow diagram illustrate acoustic paths, such as paths over which sound travels within the system.

Particular implementations of a system utilize operational models, certain of which are configured to be trained and/or run using NC systems are described in U.S. patent application Ser. No. 18/783,971 (“Machine-Learning (ML) Based Road Noise Cancelation (RNC)”), filed Jul. 25, 2024, and Ser. No. 18/783,984 (“Ear Microphone Signal Estimator and/or Projection Filter Generator for Road Noise Cancelation (RNC) System”), filed Jul. 25, 2024, each of which is incorporated by reference in its entirety.

System 100 can be configured to run as part of an audio system in a vehicle, e.g., as described in U.S. patent application Ser. No. 18/783,971, and Ser. No. 18/783,984, previously incorporated by reference. Further, system 100 can be configured as a component in an NC system, e.g., working in concert with, or as part of, additional components such as a machine learning (ML) engine. The system 100 can be configured to receive various inputs, e.g., inputs from one or more sensors such as accelerometer(s), microphone(s), and position sensor(s), and provide an output signal (also called cancelation signal) to a transducer for canceling noise in the vehicle. As described herein, the system 100 includes a cancelation module 110 that is configured to cancel noise in a vehicle based on an input from a position sensor. In a particular implementation, the position sensor(s) include an optical sensor, such as one or more cameras.

In particular implementations, the system 100 is configured to run during operation of a vehicle. The system 100 can also be configured for offline training and/or refinement, such as in scenarios using ear-mounted microphones described in U.S. patent application Ser. No. 18/783,971, and Ser. No. 18/783,984, previously incorporated by reference herein. In some cases, the cancelation module 110 is coupled with a set of sensors 120, which include among others, accelerometer(s) 122, cabin microphone(s) 124, and position sensor(s) 126 (including optical sensors 127). The cancelation module 110 is configured to provide a cancelation signal 150 to the vehicle, e.g., via one or more transducers 130. Further, the cancelation module 110 can be coupled with additional components that may provide inputs, e.g., a CAN bus in the vehicle. As described according to some implementations, the cancelation module 110 can be coupled with ear microphones 140 in some optional or training configurations (indicated in phantom), for example, where ear microphone inputs are used to train and/or refine the cancelation module 110. Such training and/or refinement scenarios are further discussed in U.S. patent application Ser. No. 18/783,971, and Ser. No. 18/783,984, previously incorporated by reference herein. It is understood that the location of ear microphones 140 depicted in FIG. 1 can represent the location of a user's ear(s) during operation of the vehicle, e.g., when ear microphones 140 are not in use.

In some examples, the transducer 130 is a near field (NF) transducer, which can be located within approximately 30 centimeters (cm) to approximately 90 cm of the user's ear. In some cases, the transducer 130 is a NF transducer located within approximately 50 cm of the user's ear, and in further cases, within approximately 30 cm of the user's ear. However, one or more transducer(s) 130 can be located outside of the near field (e.g., farther than 70 cm, 80 cm, 90 cm) relative to the user's ear(s) and configured to aid in mitigating detectable road noise.

In particular cases, the position sensor(s) 126 include optical sensors 127 such as cameras. In certain example implementations, position sensors 126 can further include force sensors located in a user's seat, for example, to detect the presence of the user in a location in the seat. In some cases, the position sensors 126 include two or more optical sensors 127 such as cameras, and the ability to detect user head position and/or ear position. It is understood that the terms “user position”, “head position”, and/or “ear position” used herein can refer to the location of the reference feature in space (e.g., in two-dimensional (2D) and/or three-dimensional (3D) coordinates), as well as the orientation of that reference feature (e.g., a direction in which the user's head is looking or a direction in which the ear canal entrance is pointed). In certain cases, inputs 170 from multiple position sensors 126 are used to determine the user head position and/or ear position. In some examples, inputs 170 from two distinct types of position sensor 126 are used to calculate a position of the user's ears in space, e.g., inputs 170 from an optical sensor 127 and one or more of a seat occupancy sensor, or a seat position sensor, detecting the location of a user's ear in 2D space. As noted herein, various inputs 170 from optical sensors 127 can be used to detect noise-impacting conditions in addition to information about the user's position.

In particular optional cases, the cancelation module 110 is configured to apply (or adjust) a cancelation signal 150 using projection filters 160 that are selected (and in some cases, generated) based on inputs 170 from position sensors 126, for example, the optical sensors 127. In some cases, a projection filter selection module 180 is configured to select projection filters 160 that are used to filter: a) an error signal 190, such as detected by a cabin microphone 124, and b) a cancelation signal 150 output by transducer(s) 130. In particular cases, the cancelation module 110 includes an adaptive module (also referred to as an adaptation module, an adaptive control filter, or ACF) 200 that adjusts the cancelation signal 150 based on the selected projection filters 160. The adaptive module 200 processes inputs 210 from accelerometer(s) 122, as well as the filtered error signal 220, to produce a cancelation (or, driver) signal 150. The cancelation (or, driver) signal 150 is provided to the transducer(s) 130 for output in canceling noise in the vehicle. It is understood that the cancelation (or, driver) signal 150 can also be combined with additional audio signals before output by transducer(s) 130, for example, when audio playback, streaming, call audio, etc., is being provided via transducer(s) 130 in the vehicle. As described herein, the projection filter selection module 180 is configured to update one or more projection filters 160 (e.g., W_{d}) that are used to filter the cancelation (or, driver) signal 150. As further noted herein, the projection filter selection module 180 is configured to update one or more additional projection filters 160 (e.g., Wᵣ) that are used to filter the error signal 190. Mixing these two filtered signals provides the estimated ear error 240.

In operation, the position sensor(s) 126 are configured to detect a position of an occupant in a vehicle, e.g., a person in a vehicle seat. In particular cases, inputs from optical sensors 127 include frame-wise inputs of user position. The optical sensor(s) 127 can be capable of providing indicators of approximate three-dimensional location of the user's head (e.g., ear locations), orientation of the user's head or other anatomical features (e.g., ears), user look direction, etc. Further, inputs from optical sensors 127 can indicate noise-impacting conditions, which may be in addition to user position and include among other things, whether additional users are present in the vehicle, whether a window or sunroof is open, the seat angle of one or more seats in the vehicle, along with noise-impacting conditions external to the vehicle (e.g., nearby construction, rough road surfaces, etc.).

Returning to FIG. 1, the transducer 130 receives cancelation signal 150 and produces a cancelation audio signal in the vehicle. The microphone (e.g., cabin microphone) 124 is configured to detect noise (e.g., cabin noise) signal 188 representative of acoustic energy at a first location in the vehicle, e.g., noise detected by cabin microphone location in the vehicle such as at a roof location, headliner location, seatback location, door location, panel location, trunk location, footrest location, pillar location, dashboard location, console location, etc.

The cabin microphone 124 captures the ambient (e.g., road) noise detectable in the cabin noise of the vehicle 188, as well as the cancelation signal 150 that is output by transducers 130 in the vehicle. The combination of these two signals provides the error signal 190, also called the microphone input to the selection module 180. Projection filters 160 filter the cancelation signal 150 and the error signal 190 to provide an estimated ear error signal 240 at the position of the occupant in the vehicle. The adaptive module 200 adjusts the cancelation signal 150 based on the estimated error signal 240.

In particular cases, the selection module 180 is configured to provide one or more of: i) estimated ear microphone signals (also called estimated error signal) 240, and ii) projection filters 160 for use in determining the estimated error signal 240.

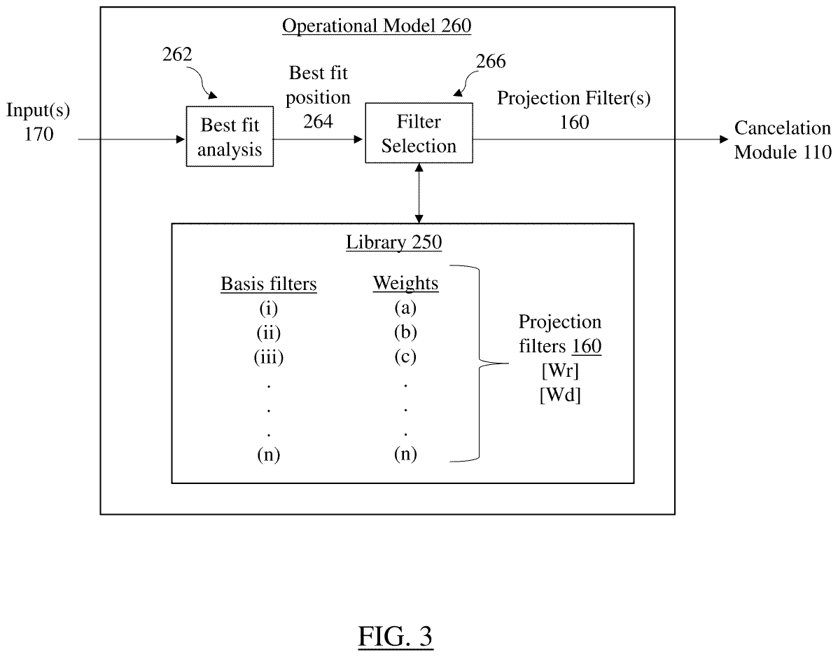

In certain optional implementations, the projection filters 160 are provided, and in certain cases, generated, by an operational model 260 that is run at the vehicle during operation, e.g., in conjunction with the cancelation module 110. As noted herein, in particular cases, the operational model 260 (e.g., including or otherwise accessing a ML engine) is configured to directly generate cancelation signals 250. FIG. 3 illustrates example data flows relating to an operational model 260 according to various implementations. In this example implementation, projection filters 160 can be stored in a library 250 and selected based on inputs 170 from the optical sensors 127, as further discussed herein.

With reference to FIGS. 1 and 3, in some examples, the set of projection filters 160 includes at least two distinct projection filters 160 including: a first projection filter (Wᵣ) that is applied to the error signal 190 from the microphone 124; and a second projection filter (W_{d}) that is applied to an input signal (e.g., cancelation signal) 150 to the transducer 130.

It is understood that while the second projection filter (W_{d}) is described as accounting for the relationship between the transducer (driver) 130 and the user's ear, that relationship can incorporate both the transducer-to-ear signal and transducer signal's impact on the signal detected by cabin microphone(s) 124. In certain of these cases, multiple transfer functions are used to account for differences between approximations from i) cabin microphones 124 to the user's ear when no sound (i.e., no cancelation) is output by transducer 130, and ii) when a cancelation signal (e.g., cancelation signal 150) is output from the transducer 130.

In some aspects, the set of projection filters 160 are configured to cancel road noise at frequencies of approximately 400 hertz (Hz) or higher. In more particular cases, the set of projection filters 160 are configured to cancel road noise at frequencies of approximately 600 Hz or higher.

In certain implementations, the set of projection filters (PF(s)) 160 includes a matrix of projection filters estimating a relationship between at least two of: a plurality of positions of the user's respective ears (e.g., from position sensor(s) 126), a position of the at least one transducer 130, and a position of the set of microphones 124 in the vehicle cabin. In some examples, the set of projection filters 160 are defined (e.g., during development and/or training) at least in part based on the inputs obtained from the set of ear-mounted microphones 140 and the inputs from the optical sensor(s) 127.

In additional examples, the projection filters 160 are generated in real-time by the model 260. In further implementations, the projection filters 160 are generated in real-time by an ML module (or, engine) 270 running at the vehicle, e.g., during operation. The ML engine 270 can be integrated in the model 260 in some cases, or can be a separate component running at system 100. In some example cases, projection filters 160 are generated based on real-time inputs 170 from the position sensors 126 (e.g., about the user position in the vehicle) as well as the accelerometers 122 (e.g., indicating speed, acceleration, and other aspects of the vehicle operation).

In certain implementations, as noted herein, the projection filter selection module 180 is configured to select the first projection filter (Wᵣ) and the second projection filter (W_{d}) from the library 250 of projection filters. In particular examples, the projection filter selection module 180 selects the first projection filter (Wᵣ) and the second projection filter (W_{d}) based on an input 170 from the position sensor 126. For example, the projection filter selection module (or, selection module) 180 receives a position input 170 from position sensor 126 including at least one coordinate indicator of a position of each ear of the occupant in the vehicle. In some cases, the coordinate indicator(s) include three-dimensional coordinate indicators of at least one of the user's ears. In additional cases, the position input 170 includes information about a center of a user's head, or another landmark indicator of the user's position in the vehicle. In certain cases, the selection module 180 includes a processing component configured to translate the position input 170 into three-dimensional coordinate indicators of the user's ear(s).

Working in conjunction with, or as a part of the model 260, selection module 180 is configured to select one or more projection filters (Wᵣ) and (W_{d}) from library 250. As illustrated in the example signal flow of FIG. 3, position inputs 170 can undergo a best fit analysis 262 to select a best fit position 264. As noted herein, best fit position 264 may represent an approximation of the user's position based on inputs 170, such that the model 260 need not store every possible permutation of user position. Filter selection 266 includes selecting a filter 160 from library 250 based on the best fit position 264. As noted herein, in some cases, filters 160 are stored as a set of Basis Filters and Weights that enable compression of filter data. The library 250 can include catalog data that maps Basis Filters to Weights for a given best fit position 264. The selected projection filter 160, derived from its Basis Filter(s) and Weight(s), is provided to the NC system 100, e.g., for use by selection module 180 and/or adaptive module 200 in adjusting the cancelation signal 150.

Returning to FIG. 1, in certain cases, the position sensor 126 includes two or more position sensors 126. In particular examples, the two or more sensors 126 includes two or more cameras positioned to detect the position of a user's head and/or ears. In some aspects, the position sensor 126 includes, or otherwise receives input from additional position indicators, such as a position of the user's seat, an identifier of the occupant (e.g., a user profile indicating which user is in a seat), or an in-seat position as indicated by an in-seat sensor such as a pressure sensor. In some examples, the optical sensors 127 provide a video feed and/or multi-frame input (e.g., to ML module 270) for use in detecting information about noise-impacting conditions. For example, noise-impacting conditions can include detecting the presence of and/or changes in nearby vehicles, road or other construction, visual indicators of road surface such as rough or dirt roads, visual indicators of wind such as trees swaying, etc. Noise-impacting conditions detectable by optical sensors 126 and/or additional sensor inputs described herein can include vehicle windows being up or down, a sunroof being open or closed, the presence of one or more users in the vehicle, the angle of one or more user seats in the vehicle, etc. Further examples of detectable noise-impacting conditions can include weather conditions (e.g., rain, wet roads, icy roads, snowfall), road conditions (e.g., the presence of potholes or expansion joints). As discussed herein with respect to training a model (e.g., ML module 270), optical frames or video feeds of optical (e.g., camera) data can be input to the ML module 270 to train that model to recognize noise-impacting conditions such as an open window, presence of additional vehicle occupants, nearby road construction, falling snow, potholes in a road, etc.

In some aspects, the set of projection filters (PF(s)) 160 are further selected based on a detected position of a seat in which the occupant is located, e.g., in a reclined position, upright position, pitched forward position, elevated position, lowered position, etc. In some examples, one or more sensor inputs (e.g., position sensor 126 inputs) are combined with user seat information such as a seat recline angle or seat position indicator to add dimensional features to the position sensor input(s).

In particular cases, the position sensor 126 (which can include optical sensor(s) 127) has a resolution that results in a delay between changes in the position of each ear of the occupant and changes in coordinate indicator. In some examples, the position sensor 126 has a resolution of approximately 40 hertz (Hz) to approximately 80 Hz, and in more particular examples, approximately 60 Hz. As such, the position sensor 126 may provide a position indicator to the selection module 180 that is not timely (i.e., no longer accurate). In certain of these cases, the selection module 180 can be configured to apply a hysteresis factor to adjustments in the cancelation signal 150 based on the resolution of the position sensor 126. The hysteresis factor can enable the selection module 180 to avoid undesirable switching of projection filters 160 and/or unnecessary changes to projection filters 160 when a user only momentarily changes position (e.g., a quick look to the left, right, or downward).

In addition to the hysteresis factor, or alternatively, the selection module 180 can include an estimator for predicting a future position of the occupant and/or a future state of a visually detectable noise-impacting condition based on a multi-frame analysis. For example, the selection module 180 can compile multiple frames of position sensor data (e.g., multiple frames from a camera) taken over time and predict a future position of the occupant, e.g., detecting a change in position trending in a given direction such as left, right, upward, downward, etc. Further, the selection module 180 can compile multiple frames of optical sensor data (e.g., multiple frames from a camera) taken over time and predict a future state of a noise-impacting condition, e.g., whether the vehicle will be nearby a construction site at a time in the future, or whether the vehicle will pass a nearby noisy vehicle within a period. In such cases, the selection module 180 can adjust the selected projection filter(s) 160 to anticipate that future position of the user (e.g., applying projection filter(s) 160 that correspond with the future position) and/or to anticipate that future noise-impacting condition (e.g., applying projection filter(s) 160 based on the predicted time before passing the construction site or the noisy vehicle). The estimator can account for the known resolution of the position sensor(s) 126 to effectively predict the future position of the user and/or the noise-impacting condition.

In some non-limiting examples, the selection module 180 can be configured to select from the library 250 of projection filters 160 associated with the set of occupant positions in the vehicle using a best-fit analysis. It is understood that the set of occupant positions in the vehicle can account for a fraction of a total number of occupant positions based on one or more seat positions. That is, the library 250 can store a fraction of the total number of occupant positions for a given user based on one or more seat positions. In these examples, and as noted herein and illustrated in FIG. 3, the set of projection filters 160 are included in the operational model 260 stored at the vehicle. In particular cases, the set of projection filters 160 are stored in the operational model 260 as a set of basis filters and corresponding weights such that a number of basis filters is less than the set of occupant positions. In some examples, the set of occupant positions includes hundreds of occupant positions and the set of basis filters includes tens of basis filters, or fewer. In further examples, the set of occupant positions includes thousands of occupant positions, and the set of basis filters includes hundreds of basis filters, or fewer. In some aspects, the set of basis filters and corresponding weights are stored using at least one compression approach. In some examples, compression approaches include PCA. In additional implementations, compression approaches include at least one of: TsNE, UMAP, or t-SNE. In additional implementations, one or more autoencoders are used to compress N dimensions. In any case, the basis filters and corresponding weights can be used to represent a relatively larger dataset of occupant positions.

In some aspects, as noted further herein, the operational model 260 is updated periodically using ML engine 270, e.g., while the vehicle is not operating. In certain examples, as noted herein, the ML engine 270 can also provide estimated ear error signals 240 directly to the cancelation module 110. In still further implementations, the ML engine 270 can provide the cancelation signal(s) 150 as a direct output to cancelation module 110, e.g., during operation of the vehicle.

As illustrated in FIG. 1, after selection module 180 selects projection filters (W_{d}) and (Wᵣ), the outputs of those filters are summed to provide the estimated ear error signal 240, which can undergo additional processing such as pseudo-inverting (driver to ear signals) of T_{de} 280 and shaping 290. After shaping, the signal is transformed using an adaptive algorithm (e.g., a least mean square (LMS) or alternate algorithms) with inputs from the shaped accelerometer signal 300, and a resulting output 220 is provided to the adaptive module 200. In various implementations, the adaptive module 200 provides the cancelation (or, driver) signal 150, for output by transducer 130. The cancelation signal 150 is also sent to the selection module 180 for filtering by projection filter (W_{d}) to provide part of the estimated ear error signal 240.

Further depicted in FIG. 1 is the transfer function (T_{dr}) from the transducer(s) 130 to the cabin microphone(s) 124, as well as a transfer function (T_{de}) from the transducer(s) 130 to the user's ear. As is known in the art, these transfer functions can be calculated in a testing environment, e.g., when the vehicle is not in an operational mode. The transfer functions are depicted in dashed lines as acoustic paths between components.

In certain offline or training modes, the user wears ear microphones 140, depicted in phantom as optional. In an operational mode, the user is not wearing ear microphones 140, and the user's ear will receive the sum of the cancelation signal 150 output by transducer(s) 130 and the cabin noise 188 in the vehicle (e.g., road noise) as received at the location of the user's ears. As such, the ear noise signal in the operational case may include an estimate (or projection) of what the user's ear hears. Transfer functions (T_{dr}) and (T_{de}) are illustrated in phantom, as optional calculations performed by the cancelation module 110.

In particular examples, the selection module 180 is configured to select a default position of the occupant based on at least one of: i) detecting the position of the occupant during startup of the vehicle, ii) detecting the position of the occupant at a cruising speed of the vehicle, iii) a profile of the occupant, or iv) at least one user input defining the default position. For example, the default position of the occupant can be detected at startup of the vehicle, and/or after the vehicle reaches a cruising speed (e.g., without significant change after a threshold period). Further, the default position can be detected based on a profile of the occupant, for example, a user profile of the person sitting in a seat in the vehicle, which can be detected via any of a number of means, such as with user identification, a default (stored) profile for one or more users, proximity of a known user device, etc. In additional implementations, a user input such as a user adjustment to the seating position or a confirmation command from the user can function as an input that defines the default position.

In particular implementations, for example, during operation of the vehicle, the estimated error signal 240 is updated in response to detecting a change in a noise-indicating condition (which can include an RNC condition) at the vehicle. In some cases, the noise-indicating condition is detected as an input from another system in the vehicle, such as a sensor input indicating a window opening or closing, a change in speed of the vehicle, obstruction of a speaker (or audio output device) in the vehicle, etc.

In still further implementations, as noted herein, the change in noise-indicating condition can be indicated by inputs 170 from position sensors 126, e.g., indicating a window opening or closing, a change in speed of the vehicle, proximity to another vehicle or an external noise source, obstruction of a speaker (or audio output device), visual indicators of road surface such as rough or dirt roads, visual indicators of wind such as trees swaying, the presence of one or more users in the vehicle, etc.

### ML Engine Training and/or Operation

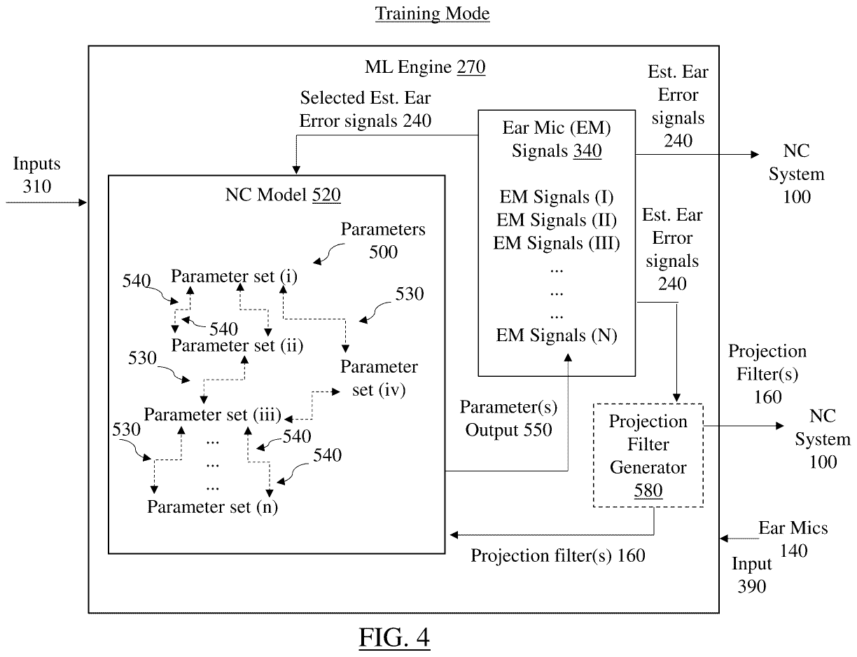

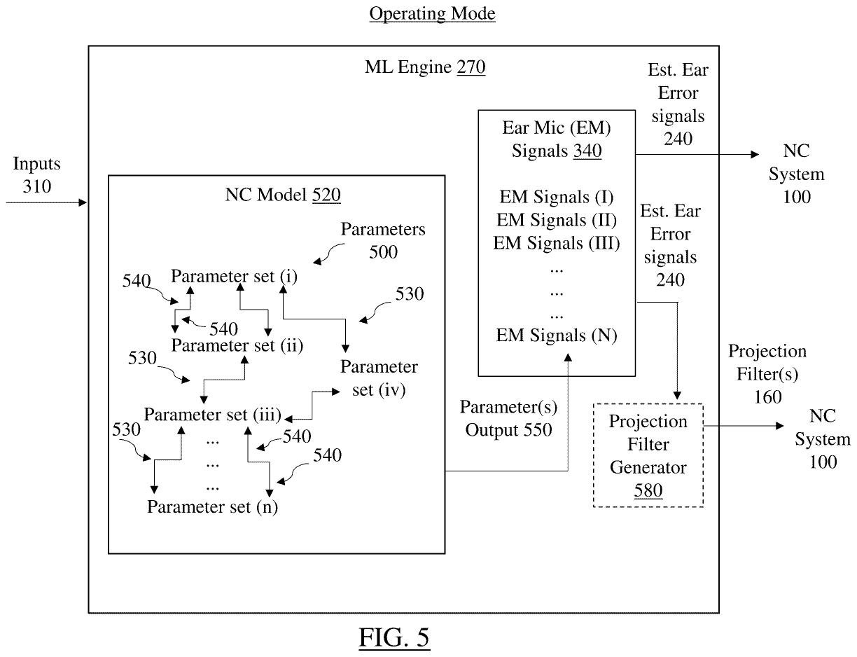

As noted herein, the operational model 260 can be updated periodically using the ML module (or, engine) 270 while the vehicle is not operating. FIGS. 4 and 5 illustrate example data flow diagrams illustrating the architecture of an ML engine 270, during a training mode and an operating mode, respectively, according to various implementations. In particular cases, the ML engine 270 includes an artificial intelligence engine that includes one or more neural networks, e.g., artificial neural networks (ANNs). In one example, the neural network layers(s) include a deeply connected layer, convolutional layer, a recurrent layer, a long short term memory layer, a nonlinear activation layer, a normalization layer, etc. In particular cases, the ML engine 270 includes a model with a set of non-linear pathways defined as sequences of steps between distinct sets of parameters. In particular cases, the ML engine 270 includes a model (e.g., a NC model) 520 with a set of non-linear pathways 530 defined as sequences of steps 540 between distinct sets (i), (ii), (iii), . . . (n) of parameters 500. While one model 520 is illustrated, it is understood that the ML engine 270 can include a plurality of models 520 for filtering detected road noise. As described herein, steps between the distinct sets of parameters are alterable during the training. In some examples, the model includes hundreds of thousands of parameters, for example, at least two-hundred thousand, at least three-hundred thousand, or at least four-hundred thousand parameters.

In certain implementations, the ML engine 270 is trained by providing inputs 310 to the ML engine 270, the inputs 310 obtained from one or more of: the position sensor 126 indicating a position of a test user of the vehicle, a set of ear-mounted microphones 140 on the test user of the vehicle, at least one transducer (e.g., NF transducer(s) proximate the test user) 130, an accelerometer 122, a set of cabin microphones 124 in the vehicle, and a controller area network (CAN) bus (not shown). In particular cases, the ML engine 270 is trained with inputs 310 from one or more optical sensors 127 indicating one or more noise-impacting conditions. As noted herein, noise-impacting conditions can include user position information, but also include one or more additional inputs relating to conditions external to the user (e.g., external road conditions, nearby traffic or other noise-generating equipment, window and/or sunroof position, etc.).

In some examples, the inputs to the ML engine 270 from the cabin microphones 124 and/or CAN bus are optional. Further, in some aspects, the ear-mounted microphones 140 only provide inputs during the training. In certain example implementations, the ear-mounted microphones 140 are located proximate an ear canal entrance of the test user, where the inputs from the set of ear-mounted microphones 140 on the test user represent at least one of: road noise as detected by the test user at each ear, or a cancelation signal 150 output by the at least one transducer 130.

With continuing reference to FIGS. 4 and 5, in various implementations, the inputs from the set of ear-mounted microphones 140 on the test user approximate detected road noise by the test user. During the training, the ML engine 270 can adapt a set of parameters 500 defining noise cancelation signals in the NC system 100 based on the inputs, and generate at least one of the following for input during an operating mode of the NC system 100: estimated ear error signals 240 based on the adapted set of parameters, or the set of projection filters 160 for use in determining an estimated ear signal at the respective ears of the test user. In some implementations, where the NC system 100 is a linear adaptive (LA) system or part of a LA module, fixed parameters in that LA system/module can be adjusted based on the estimated ear microphone signals 240.

It is understood that in some implementations, the selection module 180 is configured to select estimated ear error signals 240 (e.g., from model 260, which may use the ML engine 270) without using projection filters 160. That is, some implementations enable the selection module 180 to substitute the projection-filter based approach with estimated ear error signals 240 from the ML engine 270. For example, as shown in FIGS. 4 and 5, in certain aspects, the selection module 180 (in NC system 100) is configured to receive estimated ear error signals 240 from the ML engine 270 during system operation, and can process those estimated ear error signals 240 in the same manner as though they were generated using projection filters 160 (e.g., with pseudo-inverse, shaping, LMS, etc.). In particular implementations, the ML engine 270 is configured to generate the estimated ear error signals 240 during operation of the vehicle, e.g., based on inputs 170 from position sensors 126.

In certain example cases, the ML engine 270 includes a projection filter generator 580 that is configured to convert estimated ear error signals 240 (along with inputs 310 and inputs 390 from ear mics 140) into projection filters for use in the cancelation system 100. In other cases, projection filters can be generated by cancelation module 110 based on the estimated ear error signals 240.

In various implementations, during training, the model 520 is configured to assign a noise (e.g., road noise or other unwanted noise) component to the input (signals) 390 received from the ear microphones 140. In particular implementations, the model 520 is configured to define and/or adjust correlations (e.g., pathways 530) between additional inputs 310 and noise detected in the input 390. For example, the model 520 can be configured to define correlations such as pathways 530 between low frequency noise (e.g., below 100 Hertz (Hz)) detected in the input 390, and inputs from the optical sensors 127, CAN bus and/or inputs 210 from the accelerometer 122. In a particular example, the model 520 is configured to define correlations (e.g., pathways 530) between visual indicators of noise from optical sensors 127, RPMs, speed, and/or torque indicated by inputs from a CAN bus, and/or significant changes in acceleration (e.g., as indicated by accelerometer input 210, FIG. 1), with low frequency noise detected in input 390 at the ear mics 140. In a particular example, the ML engine 270 is configured to filter the input 390 to separate frequency ranges and/or acoustic signatures of the noise detected by ear mics 140, for example, to aid in identifying pathways 530 between noise characteristics and the additional inputs 310. In this particular example, the ML engine 270 identifies signals indicative of noise in the input 390, e.g., as low frequency acoustic signals, repetitive or recurring acoustic signals, temporary acoustic signals, and correlates those signals with inputs 310 that are attributed to noise (e.g., road noise or other environmental noise).

In certain cases, the inputs 310 are predefined as being correlated with road noise, e.g., RPM, speed, torque, braking, steering angle (in CAN bus inputs) or accelerometer inputs 370. In these cases, the ML engine 270 can define pathways 530 between parameters 500 such as low frequency signal inputs and/or acoustic signatures in inputs 390 and parameters 500 such as RPM or accelerometer thresholds, speed ranges, engagement of the braking system, or steering angle threshold from inputs 310. In certain cases, these pathways 530 are generally defined between parameters (or sets of parameters) based on predefined correlations. In other cases, these pathways 530 are defined or otherwise modified during training, e.g., where the model 520 determines a correlation between inputs 310, and inputs 390 from the ear microphones 140. In such cases, the NC model 520 is refined during training to establish new pathways 530, modify existing pathways 530, or remove pathways 530 between sets of parameters 500 based on the inputs 390 from the ear microphones 140 and additional inputs 310 from the system.

Returning to the ML engine 270 illustrated schematically in FIG. 4, steps 540 between the distinct sets of parameters 500 are alterable during the training mode. In some examples, the NC model 520 includes hundreds of thousands of parameters 500, for example, at least two-hundred thousand, at least three-hundred thousand, or at least four-hundred thousand parameters 500. In particular cases, the sets of parameters 500 (including pathways 530) are alterable during the training mode (as indicated by dashed lines), and fixed during operational mode (after training, as indicated by solid lines), e.g., as illustrated in FIG. 5. It is understood that the training can be performed multiple times, such that the sets of parameters 500 and associated pathways 530 can be altered after operating the ML engine 270.

In certain implementations, as noted herein, the NC model 520 selects output parameters 550 for defining estimated ear error signals 240. The estimated ear error signals 240 can include distinct sets (I), (II), (III), . . . (N) of ear microphone signal characteristics that define attributes of the signals detected at the ear of the user based on ear microphone signal inputs 390 and additional inputs 310, e.g., such as filters defining one or more of frequency, energy (e.g., sound pressure level), band (or range), etc.

In particular cases, the NC system 100 (which can include the ML engine 270) generates the estimated ear error signals 240 for output to the ACF 200 (FIG. 1) based on the adapted set of parameters 500. In certain optional implementations (shown in FIGS. 3 and 4), the projection filters 160 are also generated from the estimated ear error signals 240, e.g., using a projection filter generator 580. As noted herein, where available, the projection filter generator 580 can use inputs 310 and/or inputs 390 from ear mics 140 in addition to estimated ear error signals 240 to generate projection filter(s) 160. In certain cases, projection filters 160 are generated according to one or more approaches described in U.S. Pat. No. 10,629,183 and/or U.S. patent application Ser. No. 17/611,280 (US PGPUB 2022/0208168), each incorporated by reference herein in its entirety. For example, the projection filter generator 580 can include a set of relationships that map user ear positions to microphone and transducer 130 locations in the cabin, and based on the estimated ear error signals 240, project the microphone signal received at one or more microphones 124. In particular cases, the set of projection filters includes a matrix of projection filters estimating a relationship between at least two of: a plurality of positions of the user's respective ears, a position of the at least one transducer 130, and a position of the set of microphones 124 in the cabin. In particular cases, the set of projection filters 160 are defined at least in part based on the inputs obtained from the set of ear-mounted microphones 140.

As described herein, in some implementations the estimated ear error signals 240 and/or the projection filters 160 are provided to the NC system 100 during training mode (FIG. 4) and/or during operational (or, “inference”) mode (FIG. 5) for canceling road noise detectable at the user's ear. In particular cases, the estimated ear error signals 240 and/or the projection filters 160 are provided to the adaptive module 200, e.g., to produce an aggregate cancelation signal 150 for the transducer 130. In additional cases, the estimated ear error signals 240 and/or the projection filters 160 are provided as updates to the library 250, enabling the selection module 180 to provide the estimated ear error signals 240 and/or the projection filters 160 to the adaptive module 200 to aid in adaptation of cancelation signal 150. In further implementations, the estimated ear error signals 240 and/or the projection filters 160 are otherwise combined with the cancelation signal 150 to control cancelation output at the transducer 130.

In certain additional implementations (e.g., during training) an additional, optional process can include adjusting fixed parameters in an adaptive module (e.g., adaptive module 200, FIG. 1) of the NC system 100 based on the estimated ear error signals 240. In such cases, the estimated ear error signals 240 are correlated with adaptive parameters (e.g., linear adaptive or other adaptive parameters) in the adaptive module 200, and such parameters are adjusted based on deviations between the estimated ear error signals 240 and the ear microphone signal values or ranges in the adaptive module 200.

In additional optional implementations, during the training process (FIG. 4), the ML engine 270 is configured to be updated based on the generated estimated ear error signals 240 and/or the projection filters 160. In such cases, the estimated ear error signals 240 and/or the projection filters 160 are fed back into the NC model 520 to update the parameters 500 and/or pathways 530 (indicated in phantom as optional). In some cases, updating can be performed in real time in the ML engine 270, e.g., based on the generated estimated ear error signals 240 and/or projection filters 160. In other cases, the ML engine 270 can also be considered fixed, but will produce updated ear error signals 240 and/or projection filters 160 based on the inputs to the ML engine 270. In various of these cases, filters 160 in the library 250 are updated in real time.

As noted herein, steps 540 (along pathways 530) between parameters 500 can be fixed during operational mode of the ML engine 270. In other terms, during training, a common acoustic event (e.g., the sound from hitting the same pothole, in the same vehicle, at the same speed and angle, with the same ambient and vehicle conditions, e.g., inputs 310) can result in distinct estimated ear error signals 240 and/or the projection filters 160 for output based on changes in parameters 500. In such cases, during training, each parameter 500 is updated at every step 540 based on the inputs 310. In a particular example, updating each parameter 500 is based on a derivative of an error detected for each parameter 500. In contrast, during operating mode (FIG. 5), the parameters 500 and pathways 530 are fixed, and as such, estimated ear error signals 240 and/or the projection filters 160 are deterministic of input signals (e.g., inputs 310). In such cases, a common acoustic event (e.g., the sound from hitting the same pothole, in the same vehicle, at the same speed and angle, with the same ambient and vehicle conditions, e.g., inputs 310) will result in the same estimated ear error signals 240 and/or the projection filters 160 for output based on the fixed set of parameters 500.

As noted herein, the primary distinction between the operating mode of the ML engine 270 (FIG. 5) and the training mode of the ML engine 270 (FIG. 4) is that inputs 390 from ear microphones 140 are not provided to the ML engine 270 during the operating mode. In these cases, processes can include providing inputs 310 to the RNC system 300, exclusive of inputs 390 from ear microphones 140. In certain cases, the inputs 310 are provided strictly to the NC system 100 because the ML engine 270 is offline during operational mode of the NC system 100. In other cases, the ML engine 270 runs during operation of the NC system 100 but is not updated during that operational period. In still further implementations, a portion or version of the ML engine 270 is available to the NC system 100 during operation but that portion or version is not updated or otherwise configured to adjust based on feedback from the NC system 100.

In additional implementations, such as those described in U.S. patent application Ser. No. 18/783,971 (“Machine-Learning (ML) Based Road Noise Cancelation (RNC)”), filed Jul. 25, 2024, and Ser. No. 18/783,984 (“Ear Microphone Signal Estimator and/or Projection Filter Generator for Road Noise Cancelation (RNC) System”), previously incorporated by reference herein, the adaptive module 200 can be configured to apply a set of parameters defining an estimated signal detected at the user's ears based on inputs such as the estimated ear error signals 240 and/or the projection filters 160. In certain cases, parameters defining the estimated signal are fixed in the NC system 100, e.g., in the adaptive module 200. The selected parameters are based on inputs 310 from one or more sensors or CAN bus inputs, for example, inputs 170 from position sensor(s) 126 such as optical sensor(s) 127, as well as the estimated ear error signals 240 and/or the projection filters 160 from the ML engine 270. In this case, the parameters are applied based on the inputs 310 in a fixed manner, e.g., a common acoustic event will result in the same applied parameters and associated cancelation signals 150 (FIG. 1). In any case, the NC system 100 (including adaptive module 200) can be configured to generate the cancelation signal 150 for output by transducer 130 based on the applied set of parameters, e.g., in a similar manner as described in adaptive filtering in U.S. Pat. No. 10,629,183 and/or U.S. patent application Ser. No. 17/611,280 (US PGPUB 2022/0208168), each previously incorporated by reference herein.

As noted herein, various example implementations enable effective and responsive noise cancelation in an audio system using a trained ML engine 270. These implementations can beneficially relate various vehicle operating parameters as well as other detectable parameters to detected noise signals (e.g., from a user-worn microphones), and incorporate those relationships into an operational model (e.g., operational model 260) that can be used, e.g., during vehicle operation. It is understood that the ML engine 270 can also function as a stand-alone module that is either upstream or downstream of the cancelation module 110 in the signal flow. Further, as noted herein, the ML engine 270 can be configured to run during operation of the vehicle to provide estimated ear error signals 240 and/or the projection filters 160 to the cancelation module 110, e.g., based on inputs 170 from optical sensor(s) 127.

### ML-Based NC System Operation-Example Processes

As noted herein, particular implementations include approaches for generating noise cancelation and/or estimated ear error signals directly from a ML engine (e.g., ML engine 270) running at or in conjunction with a cancelation module (e.g., cancelation module 110) during operation of a vehicle. In particular cases, the ML engine is configured to generate the noise cancelation and/or estimated ear error signals based on position information about one or more users, e.g., based at least in part on inputs from position sensor(s) 126. As also noted herein, FIG. 2 illustrates a system 100A configured to perform processes in generating noise cancelation and/or estimated ear error signals directly from ML engine 270.

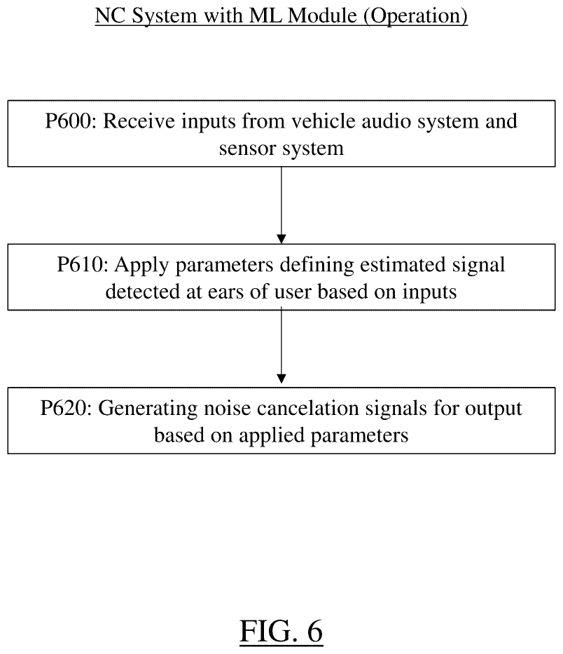

FIG. 6 is a flow diagram illustrating example processes in running a NC system such as model 260 using ML engine 270 according to various implementations. FIG. 6 is referred to in conjunction with FIGS. 1, 2, 4 and 5, with particular reference to FIG. 2. In this approach, the ML engine 270 directly receives inputs 170 from position sensor(s) 126 about the user's position in the vehicle. In particular cases, the ML engine 270 performs processes including:

P600: receives inputs from the vehicle audio system and the sensor system. Inputs can be obtained from, among others: a set of position sensors 126, at least one transducer 130, an accelerometer 122, a set of cabin microphones 124 in the vehicle, and a controller area network (CAN) bus. In particular cases, the ML engine 270 receives inputs from accelerometers 122, position sensors 126, and the vehicle audio system.

P610: applying parameters defining noise cancelation signals 150 (including, e.g., estimated ear error signals 240) based on the inputs. In some examples, the set of parameters are further applied based on a detected position of a seat in which the occupant (or user) is located. For example, inputs from position sensor(s) 126 can be combined with inputs from the vehicle operating system (e.g., CAN bus or other controller) that indicate occupant set information (e.g., position of seat base, seat back, headrest, etc.) to provide an indicator of the occupant position. The parameters defining noise cancelation signals 150 can then be applied based on the additional inputs about the user seat position; and

P620: generating noise cancelation signals 150 for output by transducer 130 (FIG. 1) based on the applied set of parameters. As noted herein, the noise cancelation signals 150 can be configured, for example, to cancel road noise at frequencies of approximately 400 Hz or higher, or approximately 600 Hz or higher.

In particular implementations, the ML engine 270 is used to update the operational model 260 that is stored at the vehicle for use during operation. Various inputs to the ML engine 270 can be optional. In certain cases, the inputs from the CAN bus include at least one vehicle input including: revolutions per minute (RPM) of the drive system, speed, torque, throttle, braking, positioning (e.g., global positioning system, GPS), steering angle, temperature (e.g., vehicle cabin temperature, drive system temperature, and/or ambient temperature), pressure (e.g., ambient pressure and/or tire pressure), seat position (e.g., as detected by a seat controller or cabin sensor(s)), user position, and/or seat occupancy (e.g., whether a seat is occupied as detected by one or more sensors in the cabin).

In certain cases, NC system 100 can be used during operation of a vehicle, and can rely at least in part on the trained ML engine (also referred to as a component or system) 270 that is trained using inputs from ear-mounted microphones. In certain cases, the ML engine 270 is trained to detect relationships between sound at the location of a cabin microphone 124 and the sound at the location of the occupant's ear, and provide corresponding noise reduction signals for managing (e.g., mitigating) noise. These relationships can be codified in the operational model 260, and in some cases, stored in library 250 in a manner that reduces latency and storage requirements for an operational system.

In particular implementations, during operation of the NC system 100 (e.g., while the vehicle is operating), the ML engine 270 is configured to apply the set of parameters and directly generate the noise cancelation signals. That is, the ML engine 270 can provide the cancelation signal(s) 150 as a direct output to cancelation module 110, e.g., during operation of the vehicle. In these implementations, the ML engine 270 need not generate or otherwise rely on projection filters 160 to generate the cancelation signals 150.

In addition to the vehicle powertrain operation and loading as described above, the relationship between the user's ear location and the location of cabin microphones 124 for various harmonics and the transfer function (secondary path) from transducer 130 to the occupant's ear may vary as environmental (e.g., cabin and/or external environmental) acoustics change. Therefore, various examples of sound cancelation systems or algorithms herein may dynamically change (adjust, select) the projection filter transfer function and/or the correction filter transfer function based on changes in environmental conditions external to the cabin and/or cabin acoustics. In various examples, changes in cabin acoustics may be communicated via digital control signals, and for example may include window conditions open/closed (which and how much), sunroof condition open/closed (and how much), hatch door condition open/closed, rear seat condition (folded down, stowed, etc.), cargo/carrying load, and occupancy such as how many occupants are present in the cabin, in which seats, and how large are they, as well as others. For example, occupancy may be estimated by data from air-bag occupant sensors in the seats. In some examples, cameras, video, and/or facial recognition systems may also provide information about cabin conditions. In particular examples described herein, position sensors 126 provide the selection module 180 with information about the position of a user's ears in the vehicle cabin, aiding in selection of projection filters that provide a best fit for cancelation at the user's position. Additional environmental conditions can be measured using external sensors such as temperature, pressure, force, etc., sensors that detect conditions external to the cabin. One or more of such sensors can be included in the sensor inputs described herein, e.g., for use during operation of the vehicle and/or during training and/or operation of the ML engine 270.

In any case, various implementations enable control of cancelation signals in a vehicle audio system based on position sensor inputs about user (or, occupant) position. For example, particular implementations use inputs from one or more position sensors in a vehicle to select and/or adjust the cancelation signal provided to the vehicle transducer(s). In certain examples, a cancelation system in a vehicle is configured to use real-time inputs from position sensors to adjust cancelation signals to account for detectable changes in user position.

Further, the approaches described according to various implementations have the technical effect of enhancing noise cancelation, in particular, ambient noise cancelation and/or road noise cancelation, in a space such as a vehicle. For example, a machine learning (ML) based noise cancelation (NC) system according to various implementations can be configured to receive inputs from one or more position sensors about the position of a user/occupant and, provide estimated ear signals for selecting a noise cancelation signal and/or directly provide the cancelation signal. In additional implementations, a machine-learning (ML) engine is used to update a noise cancelation system, and can be configured to function in a training mode and an operation (or operational) mode. In still further implementations, the ML engine is configured to directly generate cancelation signals during operation of the NC system (e.g., without using or otherwise generating projection filters). As compared with conventional systems and approaches, the disclosed cancelation system improves noise control for the user by accounting for user position.

While some examples herein have been described in regards to cancelation or reduction of road noise, certain non-limiting examples can also include cancelation of harmonics of rotating equipment, and/or enhancement or other modification of harmonic acoustic signals. In such examples, the cancelation filter as described herein may be an enhancement filter configured and adapted to provide an enhancement signal that causes the transducer to provide an enhancement audio signal to modify the sound of one or more harmonics at the occupant's ear. The feedback sensor (remote microphone) may be “projected” to the occupant's ear location in similar manner to those example systems and methods described above. Accordingly, in such examples, one or more of a projection filter and/or a correction filter may be applied in similar manner to the examples described herein to provide an estimated signal representative of the sound at the occupant's ear and may adapt the enhancement filter (the otherwise cancelation filter) to achieve a target sound of the one or more harmonics.

In various examples, enhancement, reduction, or cancelation may be performed for multiple occupant locations. For example, microphones may be included to detect acoustic energy at more than one location and multiple projection and correction filters may be stored for multiple occupant ear locations. In such examples, enhancement, reduction, or cancelation may be performed for selected occupant locations dependent upon actual occupancy and/or user selection. For instance, a rear seat occupant may be detected and example systems herein may operate to reduce noise at the ears of the rear occupant while also reducing noise at an operator's ears (e.g., in the driver's seat). However, the system may de-activate harmonic reduction at the rear occupant's ear location when it is detected that there is no rear occupant and/or based upon user selection to disable noise reduction in the rear seat location. De-activation of noise reduction at one or more locations may enable better performance of noise reduction at other locations, as such a system may minimize acoustic noise content at fewer locations.

While examples herein have been described with respect to a vehicular environment, the example systems, methods, and program code may be beneficially applied to cancelation, enhancement, or other modification of acoustic signals in other environments, such as industrial, manufacturing, factory, electric production, or other environments that may conditions producing undesired acoustic noise.

While this disclosure provides an architecture for providing noise cancelation in a vehicle, an exhaustive description of systems such as vehicle audio systems that can employ these approaches is omitted for brevity purposes. To the extent necessary, illustrative vehicle audio systems are for example described in U.S. Pat. No. 9,913,065 (issued to Bose Corporation on Mar. 6, 2018), U.S. Pat. No. 9,967,692 (issued to Bose Corporation on May 8, 2018), and U.S. Pat. No. 10,056,068 (issued to Bose Corporation on Aug. 21, 2018), the entire contents of each of which are hereby incorporated by reference. Further, various aspects of the disclosure provide an architecture for mitigating road noise detected by users in a seat. Examples of systems for detecting user movement in a seat are described in U.S. patent application Ser. No. 17/986,007 (filed Nov. 14, 2022), U.S. patent application Ser. No. 17/837,482 (filed Jun. 10, 2022), U.S. Pat. No. 11,376,991 (Ser. No. 16/916,308, filed Jun. 30, 2020 and issued on Jul. 5, 2022), and U.S. patent application Ser. No. 18/650,220 (filed Apr. 30, 2024), the entire contents of each of which are hereby incorporated by reference.

Certain examples are described as relating to mitigating noise (e.g., road noise) in a space. In particular cases, the space includes the cabin of a vehicle such as a passenger vehicle (e.g., sedan, sport utility vehicle, pickup truck, etc.), a public transit vehicle such as a train, bus or ferry boat, an airplane, a ride-sharing vehicle, etc. Certain example implementations benefit from usage in a vehicle having a number of seating locations, e.g., two or more seating locations in a passenger vehicle or public transit vehicle. However, as noted herein, various implementations provide benefits to a single user and/or a single seating location.

In certain cases, one or more microphones (e.g., an array of microphones) is positioned proximate a transducer (speaker) 130 (e.g., a NF speaker) e.g., to enable detection of acoustic signals in the user's near field. In particular cases, microphones positioned proximate the NF speaker(s) can be separately housed from the NF speaker(s). In other cases, microphones can be collectively housed with the NF speaker(s). In various implementations, microphones positioned proximate (e.g., within several centimeters up to approximately ten centimeters) the NF speaker can provide feedback and/or feedforward functions in a noise cancelation system and/or spatialization system described herein. In certain optional cases, the system can include further speakers, such as wall-mounted, cab-mounted or door-mounted speakers. In particular cases, additional speakers are outside of the near-field range relative to a first user in a seat. In particular cases, the additional speakers are approximately 100 cm or more from the user's ears while in the seat.

As noted herein, the NC system 100 is configured to deploy a set of filters to mitigate detected noise in the space (e.g., vehicle. In certain implementations, the set of filters are: i) predetermined, ii) fully adaptive, or iii) a mixture of predetermined and fully adaptive. In some examples, a fully adaptive filter relies on the use of the sensors such as microphones as an ear (or, error) microphone and/or a predictive model or simulation of the environment in the space to filter the audio signals. Additional details of adaptive filters in digital signal processing are included in U.S. Pat. No. 9,633,647 (Self-Tuning Transfer Function for Adaptive Filtering) filed Oct. 4, 2016, which is entirely incorporated by reference herein.

In various implementations, the NC system 100 can deploy a set of filters to audio signal inputs to reduce noise detected by one or more sensors (e.g., position sensors 126, microphones 124, accelerometers 122). In certain aspects, the NC system 100 deploys distinct filters (e.g., specific filters and/or sub-sets of filters) to provide at least one of: i) seat-specific noise cancelation settings for the audio output, ii) user-specific noise cancelation settings for the audio output, iii) user-adjustable noise cancelation settings for the audio output, or iv) differential user-adjustable noise cancelation settings for the audio output. In still further examples, the controller includes noise cancelation settings that are user-adjustable, e.g., via an interface at the vehicle control system or via an application running on a connected additional device such as a smart device.

In some aspects, such as where the NC system 100 is part of a vehicle, noise cancelation (NC) settings can be tailored to cancel road noise and/or engine noise, tire cavity and/or cabin boom noise. Further description of NC settings and noise control in vehicles is described in U.S. Pat. No. 10,839,786 (Systems and Methods for Canceling Road Noise in a Microphone Signal), filed Jun. 17, 2019, and U.S. Pat. No. 9,928,823 (Adaptive Transducer Calibration for Fixed Feedforward Noise Attenuation Systems), filed Aug. 12, 2016, and U.S. patent application Ser. No. 18/971,140 (“Road Noise Cancelation (RNC) with User Position Tracking”, Attorney Docket No. AS-24-290-US), filed Dec. 6, 2024; each of which is entirely incorporated by reference herein.

Particular implementations are described as including an ML engine 270 that is configured to control audio output in mitigating noise detected by the user with transducers 130 such as NF speakers or other mid-field or far-field speakers. In the example where system 100 is part of a vehicle, the ML engine 270 can be configured to adjust NC settings to cancel or otherwise mitigate road noise from operation of the vehicle, and/or vehicle noise. In particular cases, adjusting NC settings can include applying a narrowband feedforward or feedback control to a noise signal at the speakers (e.g., transducer(s) 130) based on input(s) from one or more reference sensors (e.g., position sensors 126, accelerometers 122, microphones 124, etc.). In some cases, the input from the reference sensor indicates an RPM level of the vehicle or a target frequency of noise in the space (e.g., where space includes a vehicle cabin), for example, as indicated by an input from sensors and/or additional microphones in the system 100. In certain cases, the reference sensor can include a camera, a microphone, an accelerometer (e.g., an IMU) or a strain sensor. In some additional aspects, adjusting the NC setting includes applying a broadband feedforward control to a noise signal at a NF speaker based on an input from a reference sensor in the space. The reference sensor for the feedforward control can include one or more of the same reference sensors used in the narrowband NC setting adjustment, or can include distinct reference sensors. Examples of narrowband noise include engine and/or motor harmonics, noise from detection systems such as LiDAR motor(s), tire cavity resonance, cabin boom noise and/or compressor (e.g., air conditioning compressor) noise. Examples of broadband noise that the system is capable of controlling (and in some cases canceling) include road noise such as structure-borne road noise. In particular examples, tire cavity resonance and cabin boom are tonal subsets of broadband noise, even though generally classified as narrowband noise. In certain implementations, one or more portions of the system 100 are configured to focus noise cancelation on narrowband noise, enhancing cancelation within the relatively narrower band of noise (as compared with broadband cancelation).

Machine learning models described herein may for example be implemented in software, hardware, or a combination thereof. Machine learning models described herein may include a deep neural network (DNN), which is a type of artificial neural network that is composed of multiple layers of interconnected nodes or artificial neurons. A DNN may for example include convolution neural networks (CNN) designed to work with multi-dimensional grid-like data (e.g., a spectrogram), recurrent neural networks (RNNs) or variants like Long Short-Term Memory (LSTM), which can be combined with CNNs.

DNNs generally include an Input Layer that receives the raw data or features. Each neuron in this layer corresponds to an input feature. For example, in image recognition, each neuron might represent a pixel's intensity value. DNNs further include a Weighted Sum and Activation Function in which each connection between neurons in adjacent layers has an associated weight. The input data is multiplied by these weights, and the results are summed up for each neuron in the next layer. An activation function is applied to this weighted sum to introduce non-linearity and make the network capable of learning complex relationships. Common activation functions include ReLU (Rectified Linear Unit), Sigmoid, and Tanh. Between the input and output layers there can be one or more Hidden Layers. These layers contain neurons that learn progressively more abstract and complex features from the input data. Each neuron in a hidden layer receives inputs from all neurons in the previous layer, applies the weighted sum and activation function, and passes the result to the next layer. The last layer in the DNN is the Output Layer, which produces the final result of the network's computation. The number of neurons in the output layer depends on the specific task. For instance, in binary classification, there might be one neuron for each class, whereas in multi-class classification, there may be multiple neurons per class.

The DNN is trained for example using supervised learning, e.g., by repeatedly presenting training data to the network, calculating the loss, and updating the weights using backpropagation and optimization algorithms. This process continues until the model converges to a satisfactory level of performance. The process may include use of a loss function that measures the difference between the predicted output and the actual target. Common loss functions include mean squared error for regression tasks and categorical cross-entropy for classification tasks. Optimization algorithms adjust the weights in the network to minimize the loss function iteratively. Gradient descent, stochastic gradient descent (SGD), and Adam, may for example be utilized.

Training for supervised learning may utilize a dataset that includes input data (features) and corresponding target outputs (labels). Once trained, the DNN can be used for inference on new, unseen data. The input data is passed through the network, and the output provides predictions or classifications based on what the network has learned during training. The DNN may be periodically evaluated on a separate validation dataset to monitor how well it generalizes to unseen data. This helps prevent overfitting, where the model becomes too specialized on the training data.

Various wireless connection scenarios are described herein. It is understood that any number of wireless connection and/or communication protocols can be used to couple devices in a space. Examples of wireless connection scenarios and triggers for connecting wireless devices are described in further detail in U.S. patent application Ser. No. 17/714,253 (filed on Apr. 4, 2022) and Ser. No. 17/314,270 (filed on May 7, 2021), each of which is hereby incorporated by reference in its entirety).

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations. Further, although certain embodiments are described above as not requiring manual intervention to initiate pairing, in some embodiments manual intervention may be required to complete the pairing (e.g., “Are you sure?” presented to a user of the source/host device), for instance to provide further security aspects to the approach.

In some implementations, the host-based elements of the approach are implemented in a software module (e.g., an “App”) that is downloaded and installed on the source/host (e.g., a “smartphone”), in order to provide the spatialized audio output control aspects according to the approaches described above.

It is understood that the relative proportions, sizes and shapes of the system and components and features thereof as shown in the FIGURES included herein can be merely illustrative of such physical attributes of these components. That is, these proportions, shapes and sizes can be modified according to various implementations to fit a variety of products. For example, while a substantially block (or rectangular cross-sectional) shaped loudspeaker may be shown according to particular implementations, it is understood that the loudspeaker could also take on other three-dimensional shapes in order to provide acoustic functions described herein.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Though the elements of several views of the drawings herein may be shown and described as discrete elements in a block diagram and may be referred to as “circuitry,” unless otherwise indicated, the elements may be implemented as one of, or a combination of, analog circuitry, digital circuitry, or one or more microprocessors executing software instructions. The software instructions may include digital signal processing (DSP) instructions. Unless otherwise indicated, signal lines may be implemented as discrete analog or digital signal lines, as a single discrete digital signal line with appropriate signal processing to process separate streams of audio signals, or as elements of a wireless communication system. Some of the processing operations may be expressed in terms of the calculation and application of coefficients. The equivalent of calculating and applying coefficients can be performed by other analog or digital signal processing techniques and are included within the scope of this patent application. Unless otherwise indicated, audio signals may be encoded in either digital or analog form; conventional digital-to-analog or analog-to-digital converters may not be shown in the figures.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

We claim:

1. A system comprising:
a vehicle audio system including at least one transducer for providing an audio output to an occupant in a vehicle;
a position sensor for indicating a position of the occupant in the vehicle;
a set of additional sensors including an accelerometer; and
a machine learning (ML) based road noise cancelation (RNC) system connected with the vehicle audio system and the position sensor, the ML based RNC system configured to:
receive inputs from the vehicle audio system, the position sensor, and the accelerometer;
apply a set of parameters defining noise cancelation signals based on the inputs; and
generate noise cancelation signals for output by the at least one transducer based on the applied set of parameters.

2. The system of claim 1, wherein the set of parameters are further applied based on a detected position of a seat in which the occupant is located.

3. The system of claim 1, wherein the noise cancelation signals are configured to cancel road noise at frequencies of approximately 400 hertz (Hz) or higher.

4. The RNC system of claim 3, wherein the noise cancelation signals are configured to cancel road noise at frequencies of approximately 600 Hz or higher.

5. The system of claim 1, wherein the ML based RNC system is configured to run in a plurality of modes.

6. The system of claim 1, wherein the position sensor provides at least one coordinate indicator of a position of each ear of the occupant of the vehicle.

7. The system of claim 6, wherein the position sensor has a resolution that results in a delay between changes in the position of each ear of the occupant and changes in coordinate indicator.

8. The system of claim 7, wherein a hysteresis factor is applied to adjustments in the cancelation signal based on the resolution of the position sensor.

9. The system of claim 1, wherein the RNC system is configured to select a default position of the occupant based on at least one of:
i) detecting the position of the occupant during startup of the vehicle,
ii) detecting the position of the occupant at a cruising speed of the vehicle,
iii) a profile of the occupant, or
iv) at least one occupant input defining the default position.

10. The system of claim 1, wherein the position sensor includes two or more optical sensors.

11. The system of claim 1, wherein the ML based RNC system is further configured to receive inputs from the set of additional sensors including: a set of cabin microphones in the vehicle, and a controller area network (CAN) bus.

12. The system of claim 11, wherein the inputs from the CAN bus include at least one vehicle input including: revolutions per minute (RPM) of the drive system, speed, torque, throttle, braking, positioning, steering angle, temperature, pressure, seat position, or seat occupancy.

13. A method of controlling road noise in a vehicle with a machine learning (ML) based road noise cancelation (RNC) system, the method comprising:
receiving inputs from a vehicle audio system, a position sensor, and an accelerometer, wherein the position sensor indicates a position of an occupant in the vehicle;
applying a set of parameters defining noise cancelation signals based on the inputs; and
generating noise cancelation signals for output by at least one transducer in the vehicle audio system based on the applied set of parameters.

14. The method of claim 13, wherein the set of parameters are further applied based on a detected position of a seat in which the occupant is located.

15. The method of claim 13, wherein the noise cancelation signals are configured to cancel road noise at frequencies of approximately 400 hertz (Hz) or higher.

16. The method of claim 13, wherein the ML based RNC system is further configured to receive inputs from the set of additional sensors including: a set of cabin microphones in the vehicle, and a controller area network (CAN) bus.

17. The method of claim 13, wherein the ML based RNC system is configured to run in a plurality of modes.

18. The method of claim 13, wherein the position sensor provides at least one coordinate indicator of a position of each ear of the occupant of the vehicle.

19. The method of claim 13, wherein the position sensor includes two or more optical sensors.
